(19) United States
(12) Patent Application Publication
(10) Pub. No.: US 2011/0094451 A1
(43) Pub. Date: Apr. 28, 2011

(54) Magnetic field generator compressed into a housing using exothermic polymer for stabilizer used for shark deterrent

(76) Inventor: Patrick Lee Ward, Tarpon Springs, FL (US)

(21) Appl. No.: 12/925,610

(22) Filed: Oct. 26, 2010

Related U.S. Application Data
(60) Provisional application No. 61/255,150, filed on Oct. 27, 2009.

(51) Int. Cl. A01K 61/00

(52) U.S. Cl. 119/220

(57) ABSTRACT

Uses a specific magnetic field for shark deterrent. Over stimulates the electroreceptors in sharks and stingrays.

This application claims priority from provisional application Ser. No. 61/255,150 filed Oct. 27, 2009.

### BRIEF DESCRIPTION OF THE DRAWINGS

FIG. 1 shows a perspective view of an aqua shield in accordance with an embodiment of the present invention;

FIG. 2 shows a section view of an aqua shield in accordance with an embodiment of the present invention;

FIG. 3 shows a section view of an aqua shield in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally relates to an aqua shield device.

Embodiments of the present invention include a magnetic field generator, compressed into a housing that may use an exothermic polymer as a stabilizer that is used as a shark deterrent. By using a compressed and repelling field generated from magnets, an alternate field suitable for a shark's general environment may be mimicked so that it over stimulates a shark's electroreceptor.

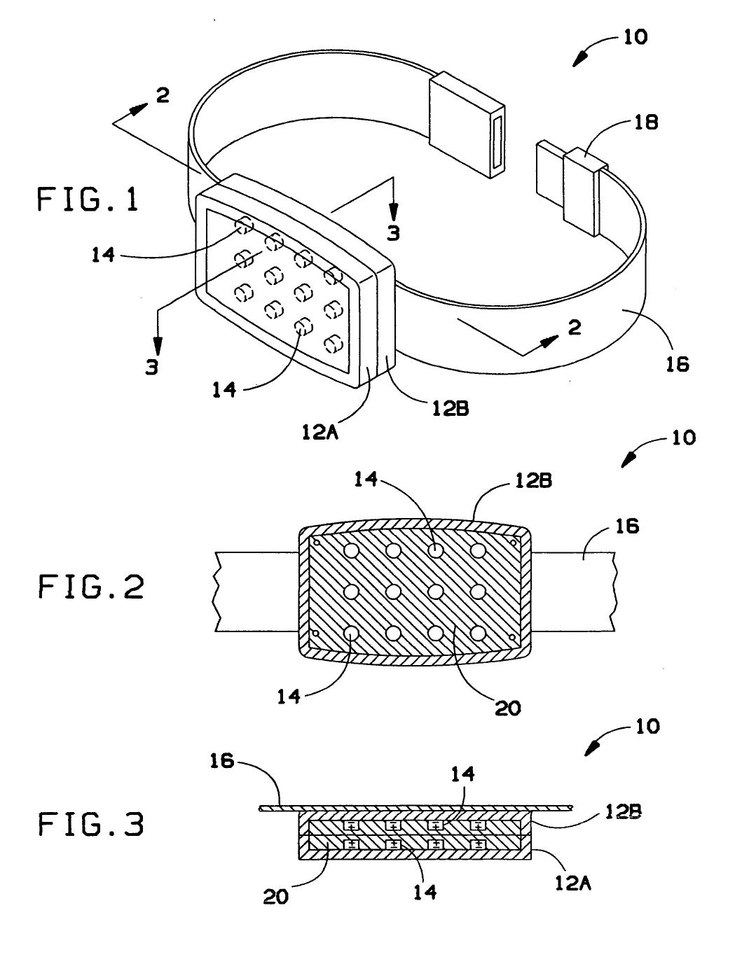

Referring to FIG. 1 through FIG. 3, an aqua shield device 10 may comprise a plastic enclosure including a front plastic enclosure 12A and a back plastic enclosure 12B. The plastic enclosure may be attached to a belt 16 that may be closed via clip 18.

The plastic enclosure may contain ⅜″×¼″ neodymium-boron axially magnetized disk magnets 14 that may be arranged and seated in a permanent repelling field arrangement. The plastic enclosure may provide containment and may be waterproof, and may further provide minimal shielding to help propagate exterior field strength exerted by disk magnets 14.

To encapsulate and stabilize the disk magnets 14, a two-component exothermic epoxy resin 20 may be used. The epoxy resin 20 may provide a stable environment to prevent shifting of the repelling forces emanating from the disk magnets 14, and may further provide for a permanent and waterproof encapsulation.

In use, the aqua shield device 10 may be worn around a user's body via the belt 16 and clip 18, or may be inserted into life vests and/or floatation devices, so that the aqua shield device may be used as a shark deterrent. Further, the aqua shield device 10 may be used as a stingray deterrent as well as a shark deterrent.

It should be understood, of course, that the foregoing relates to exemplary embodiments of the invention and that modifications may be made without departing from the spirit and scope of the invention as set forth in the following claims.

We claim:

1. A device comprising:
an enclosure;
a plurality of disk magnets, arranged and seated in a permanent repelling field arrangement within the enclosure, that propagate exterior field strength to over stimulate electroreceptors of an animal; and
an epoxy resin within the enclosure that prevents shifting of the disk magnets.
